(19) United States
(12) Patent Application Publication
(10) Pub. No.: US 2021/0374092 A1
(43) Pub. Date: Dec. 2, 2021

(54) COMPUTER-IMPLEMENTED METHOD OF PROVIDING TROUBLESHOOTING SUPPORT AND MAINTENANCE INSTRUCTIONS FOR SERVICING ASSETS

(71) Applicant: Lexx Technologies Pty Ltd, St Leonards (AU)

(72) Inventor: Anant Sahay, Pymble (AU)

(21) Appl. No.: 17/332,542

(22) Filed: May 27, 2021

Related U.S. Application Data
(60) Provisional application No. 63/031,751, filed on May 29, 2020.

(51) Int. Cl. G06F 16/11; G06F 16/13; G06N 5/02; G06N 20/00; G05B 19/418

(52) U.S. Cl. CPC G06F 16/116; G06F 16/13; G05B 19/41865; G06N 20/00; G05B 19/4183; G06N 5/025

(57) ABSTRACT

A computer-implemented method of providing troubleshooting support and maintenance instructions for servicing assets including plant, equipment, and systems.

### TECHNICAL FIELD

The present disclosure relates broadly to a computer-implemented method of providing troubleshooting support and maintenance instructions for servicing assets including plant, equipment, and systems. The disclosure is also broadly directed to a computer system for providing or displaying troubleshooting support and maintenance instructions for servicing assets. The disclosure is further generally directed to a computer-implemented method and a computer system for identifying technical faults defects in assets to be serviced.

### BACKGROUND

Existing asset and knowledge management software is used in the maintenance and repair of typically complex or complicated plant, equipment and systems. This software falls generally into four categories, namely i) enterprise asset management software, ii) maintenance management software, and iii) field services/work order management software, and iv) document/knowledge management software. Enterprise Asset Management and Maintenance Management software is used largely for the purposes of reporting for the management of physical asset lifecycle, including the performance, quality and financial health of plant, property and equipment. For critical assets that impact the occupational health and safety of the workforce or the health and safety of the public, both Enterprise Asset Management and Maintenance Management software must be configured to comply with various regulations internationally, regionally and across varying government entities and international standards boards when recording defects, categorising faults and maintaining general maintenance records. Field services software is aimed at mobile workforces, and largely mobile technicians enabling work plans and job schedules to be communicated and for information and work packages for inspections, installation, repairs, replacement and overhaul to be exchanged between a maintenance management organisation and the engineers or technicians in the field. Document and knowledge management software typically stores artefacts, information and data pertaining to an organisation's institutional knowledge. This may include notes, procedures, images, video, documents, presentations and other knowledge artefacts that support a maintenance organisation, for example, to capture the collective knowledge of their technicians and engineers in order to learn from certain known faults or defects, errors and patterns and to support efforts institutionalise better maintenance practices across the organisation.

Certain known asset and knowledge management systems and the associated software each require and host varying data structures, are disparate from one another, require additional training of engineers or technicians for suitable use and often underutilised by engineers or technicians when they are conducting their inspections, repairs, replacements and overhaul of plant, equipment and systems. Furthermore, each of these systems require different data or information sources, across varying structures language taxonomies and nomenclatures and do not have the capability to synthesize into a single consumable resource for a maintenance engineer or technician. Furthermore, where there is higher data density, there is greater latency between plant performance observations and an engineer or technician's maintenance workflow, delaying their ability to incorporate current observations and patterns into their analysis and maintenance tasks. Further exacerbating an engineer or technician's ability to utilise data and information from these systems is that they must learn and navigate a database language structure that has little correspondence to their natural or vocational language and syntax. These are the factors that hinder an engineer or technician from suitably and efficiently utilising these known software systems to sift through and create accurate assessments, prognoses and recommendations in the general field of asset management, insofar as maintaining asset health is concerned. Misreading, misinterpreting or misusing the data and information associated with these systems can have severe consequences particularly when troubleshooting systems, plant and equipment. Consequences include but are not limited to a) greater unplanned plant/equipment/system downtime; b) overutilization of components, such as spare parts, for example; and c) non-safety or regulatory compliance of the operation of the plant, equipment and systems.

### SUMMARY OF DISCLOSURE

According to a first aspect of the present disclosure there is provided a computer-implemented method of providing troubleshooting support and maintenance instructions for an asset, said method comprising the steps of:
ingesting technical information relevant to an asset to be serviced;
processing the ingested technical information to provide structured service data, said processing based on maintenance requirements and information associated with the asset;
receiving a technical observation from an engineer or technician tasked in servicing of the asset;
interrogating the structured service data based on said technical observation from the engineer or technician;
providing troubleshooting support and maintenance instructions for the asset and derived from said interrogation of the structured service data, said troubleshooting support and maintenance instructions enabling servicing of the asset by the engineer or technician.

According to a second aspect of the disclosure there is provided a computer-implemented method of identifying technical faults or defects in an asset to be serviced, said method comprising the steps of:
ingesting technical information relevant to the asset;
processing the ingested technical information to provide structured service data, said processing based on maintenance requirements and information associated with the asset;
receiving a technical observation from an engineer or technician tasked in servicing of the asset;
interrogating the structured service data based on said one or more technical observation from the engineer or technician;
identifying technical faults or defects in the asset and derived from said interrogation of the structured service data.

In certain embodiments, the method also comprises the step of presenting the structured service data to an application layer through which the structured service data is interrogated. In certain such embodiments, the structured service data is presented to the application layer in a unified maintenance modelling language staged on a non-relational database.

In one embodiment, the step of processing the ingested technical information involves:
i) transforming data associated with said ingested information into a standardised format file and data model including transformed data having common information data sets;
ii) shaping the standardised format file by editing at least some of the transformed data based on the maintenance requirements and information to provide a contextual knowledge file and database.
   In various embodiments, said processing step further involves cleansing the contextual knowledge file by indexing at least some data from the contextual knowledge file based on statistical correlation of said at least some data to the maintenance requirements and information associated with the asset to provide an indexable knowledge file. In certain embodiments, said processing step also involves transforming the indexable knowledge file into a unified maintenance file of the non-relational database including the structured service data for interrogation based on said one or more technical queries from the engineer or technician. In certain embodiments, said processing step involves a preliminary step of translating data associated with the ingested technical information using statistical machine translation to converge data types and structures of said ingested information prior to transformation of said data into the standardised format file and data model.

In certain embodiments, the computer-implemented method also comprises the steps of:
in response to the technical observation from the engineer or technician, presenting a plurality of potential technical faults or defects for the asset derived from said interrogation of the structured service data;
enabling selection by the engineer or technician of one of the plurality of potential technical faults or defects;
providing a structured workflow configured to solicit a response from the engineer or technician based on which further interrogation of the structured service data is effected in order to determine the maintenance instructions required to enable servicing of the asset.

In certain embodiments, the response is solicited from the engineer or technician by presenting one or more troubleshooting instructions contained within the structured workflow. In certain of these embodiments, the step of presenting the plurality of potential faults or defects involves:
i) weighting the potential faults or defects depending on their relevance to the technical observation, said weighting being derived from the interrogation of the structured service data;
ii) displaying the potential faults or defects dependent on their weighting.

In certain embodiments, the steps of providing the structured workflow involves dynamic construction of said workflow by the application of machine learning algorithms associated with the asset to be serviced by the engineer or technician. In certain such embodiments, the provision of the structured workflow also involves dynamic construction of said workflow by application of machine learning algorithms associated with behaviours of the engineer or technician tasked in servicing of the asset as well as behaviours of the asset.

In certain embodiments, the step of receiving a technical observation involves the engineer or technician using natural language in the technical observation based on which the structured service data is interrogated. In certain embodiments, the solicitation of the response in the structured workflow also or alternatively involves use of natural language by the engineer or technician.

In certain embodiments, the step of ingesting technical information involves scanning or otherwise digitally imaging technical documents from which the technical information is obtained in an electronic form. Alternatively or additionally the step of ingesting technical information involves extracting the technical information from a Local Area Network (LAN), Wide Area Network (WAN), or an internet-enabled device associated with the asset to be serviced.

In certain embodiments, the method also comprises the step of the engineer or technician imaging the asset to be serviced wherein said imaging is effective in identifying the asset for at least partly-automated interrogation of the structured service data depending on the identified asset. Alternatively the asset is identified by the engineer or technician using a neuroimaging device associated with the engineer or technician for brain recognition of the asset to be serviced.

In certain embodiments, the step of ingesting technical information involves ingesting text, audio and/or visual data types including historical and forecast technical information. In certain such embodiments, the technical information ingested includes predetermined, partially determined, and undetermined data structures. In certain such embodiments, the technical information to be ingested resides in tangible and non-tangible forms including paper, electronic, non-transitory computer readable medium, and memory-recall.

According to a third aspect of the disclosure there is provided a computer system for providing troubleshooting support and maintenance instructions for servicing an asset, said system comprising:
a processor; and
a memory device which stores a plurality of instructions which when executed by the processor, cause the processor to:
   i) facilitate the ingestion of technical information relevant to an asset to be serviced;
   ii) process the ingested technical information to provide structured service data, said processing based on maintenance requirements and information associated with the asset;
   iii) receive one or more technical observations from an engineer or technician tasked in servicing the asset;
   iv) interrogate the structured service data based on said one or more technical observations; and
   v) provide troubleshooting support and maintenance instructions for the asset and derived from said interrogation of the structured service data, said troubleshooting support and maintenance instructions enabling servicing of the asset by the engineer or technician.

According to a fourth aspect of the disclosure there is provided a computer system for identifying technical faults or defects in an asset to be serviced, said system comprising:
a processor; and
a memory device which stores a plurality of instructions which when executed by the processor, cause the processor to:
   i) facilitate the ingestion of technical information relevant to an asset to be serviced;
   ii) process the ingested technical information to provide structured service data, said processing based on maintenance requirements and information associated with the asset;
   iii) receive one or more technical observations from an engineer or technician tasked in servicing the asset;
   iv) interrogate the structured service data based on said one or more technical observations; and
   v) identify technical faults or defects in the asset and derived from said interrogation of the structured service data.

According to a fifth aspect of the disclosure there is provided a computer system for displaying troubleshooting support and maintenance instructions for servicing an asset, said system comprising:
an input device;
a display device associated with the input device;
a processor; and
a memory device which stores a plurality of instructions which when executed by the processor, cause the processor to:
   i) process technical information relevant to an asset to be serviced to provide structured service data, said processing based on maintenance requirements and information associated with the asset;
   ii) receive one or more technical observations at the input device from an engineer or technician tasked in servicing the asset;
   iii) interrogate the structured service data based on said one or more technical observations;
   iv) cause the display device to display troubleshooting support and maintenance instructions derived from said interrogation of the structured service data, said troubleshooting support and maintenance instructions enabling servicing of the asset by the engineer or technician.

According to a sixth aspect of the disclosure there is provided a computer system for displaying technical faults or defects in an asset to be serviced, said system comprising:
an input device;
a display device associated with the input device;
a processor; and
a memory device which stores a plurality of instructions which when executed by the processor, cause the processor to:
   i) process technical information relevant to an asset to be serviced to provide structured service data, said processing based on maintenance requirements and information associated with the asset;
   ii) receive one or more technical observations at the input device from an engineer or technician tasked in servicing the asset;
   iii) interrogate the structured service data based on said one or more technical observations;
   iv) cause the display device to display technical faults or defects in the asset and derived from said interrogation of the structured service data.

In certain embodiments, the method also comprises the step of presenting the structured service data to an application layer through which the structured service data is interrogated. In certain of these embodiments, the structured service data is presented to the application layer in a unified maintenance modelling language staged on a non-relational database.

Additional features are described in, and will be apparent from the following Detailed Description and the figures.

### BRIEF DESCRIPTION OF DRAWINGS

In order to achieve a better understanding of the nature of the present disclosure, an example embodiment of a computer-implemented method and a computer system for servicing assets or identifying technical faults or defects in assets will now be described, by way of example only, with reference to the accompanying illustrations in which:

FIGS. 1A and 1B (collectively (“FIG. 1”) are a schematic illustration of a computer-implemented method and computer system according to one embodiment of the disclosure to be integrated with Enterprise Resource Planning (ERP) software in aviation;

FIGS. 2A, 2B, 2C and 2D (collectively “FIG. 2”) are a schematic illustration of the embodiment of FIG. 1 including back-end steps in constructing structured service data for interrogation by an engineer or technician for either the provision of troubleshooting support and maintenance instructions, or the identification of technical faults or defects in assets to be serviced;

FIGS. 3A and 3B are exemplary screenshots illustrating front-end steps of an example embodiment of FIGS. 1 and 2 involving interrogation of the structured service data; and

FIGS. 4A and 4B are exemplary screenshots showing further front-end steps of an example embodiment involving presentation of a structured workflow including troubleshooting instructions to assist with the provision of troubleshooting support and maintenance instructions or the identification of technical faults or defects in the asset.

### DETAILED DESCRIPTION

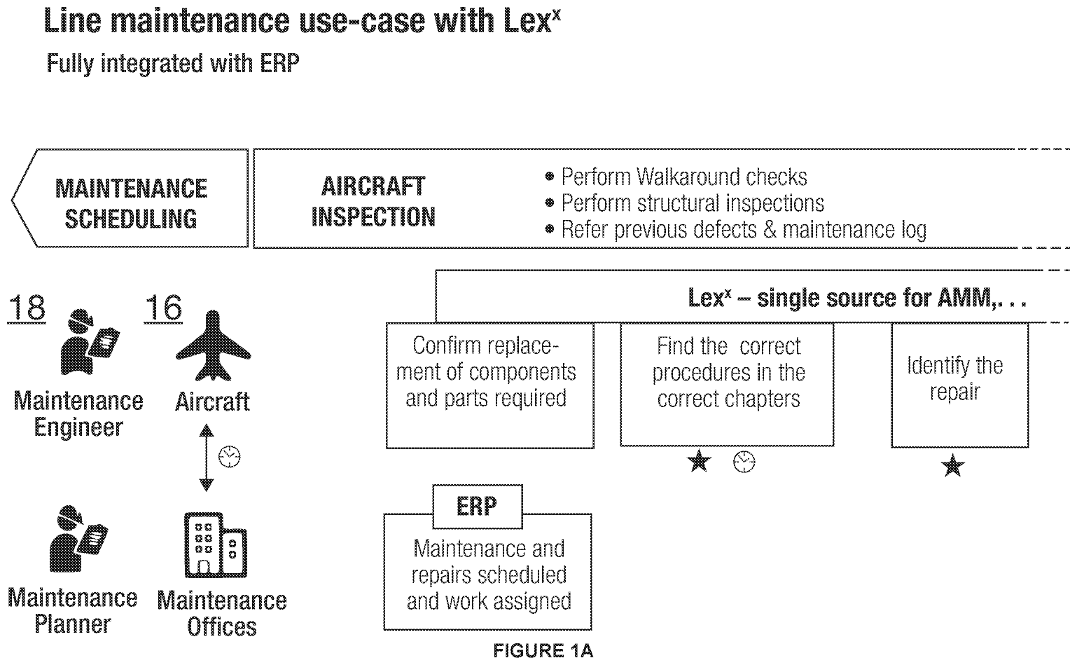

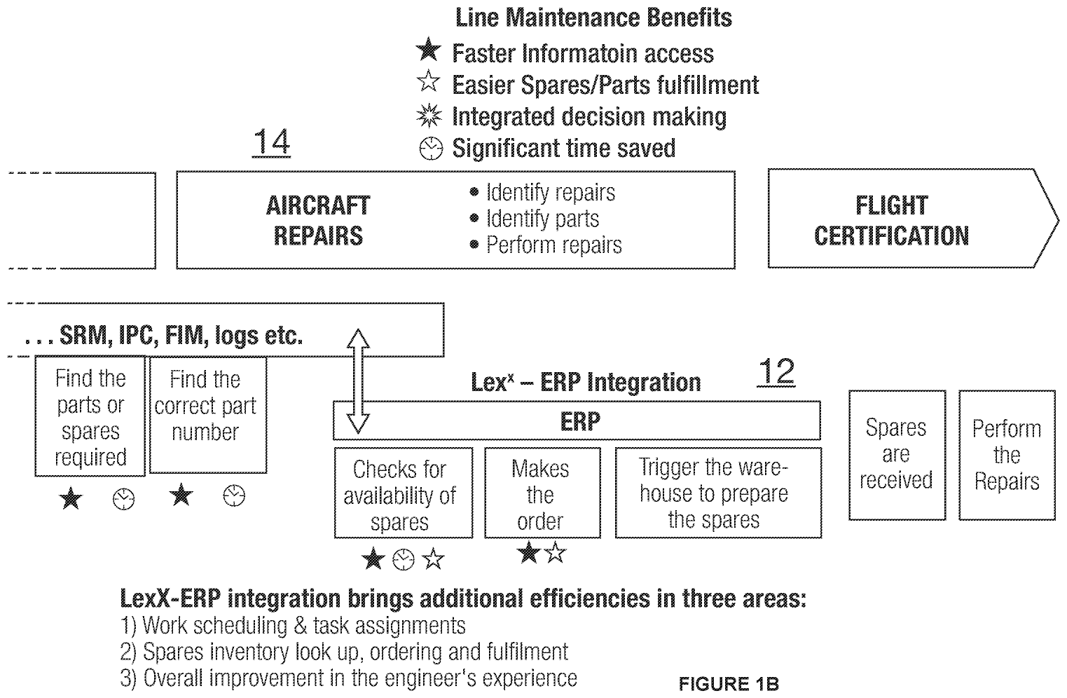

As shown in FIG. 1, there is one embodiment of a computer system depicted generally at 10 to be integrated with ERP software 12 in providing troubleshooting support and maintenance instructions 14 for servicing assets, or identifying technical faults or defects in the assets. In this illustration, the computer-implemented method and associated system 10 are deployed in aviation where the asset to be serviced is associated with an aircraft 16. The provision of maintenance instructions for the equipment 16 enables servicing of the equipment 16 by an engineer or technician or in this case a maintenance engineer 18.

It is to be understood that the technology of the present invention is equally applicable to assets in the clean energy sector. For example, the computer-implemented method or computer system are suited for deployment in the wind energy industry and more particularly for operations and maintenance associated with wind turbines in wind farms. This suitability of the present invention to wind turbines is due to a number of factors which in combination are unique to wind turbines including the fact that they are large and complex, and often sited in remote locations, making them inherently difficult and expensive to maintain.

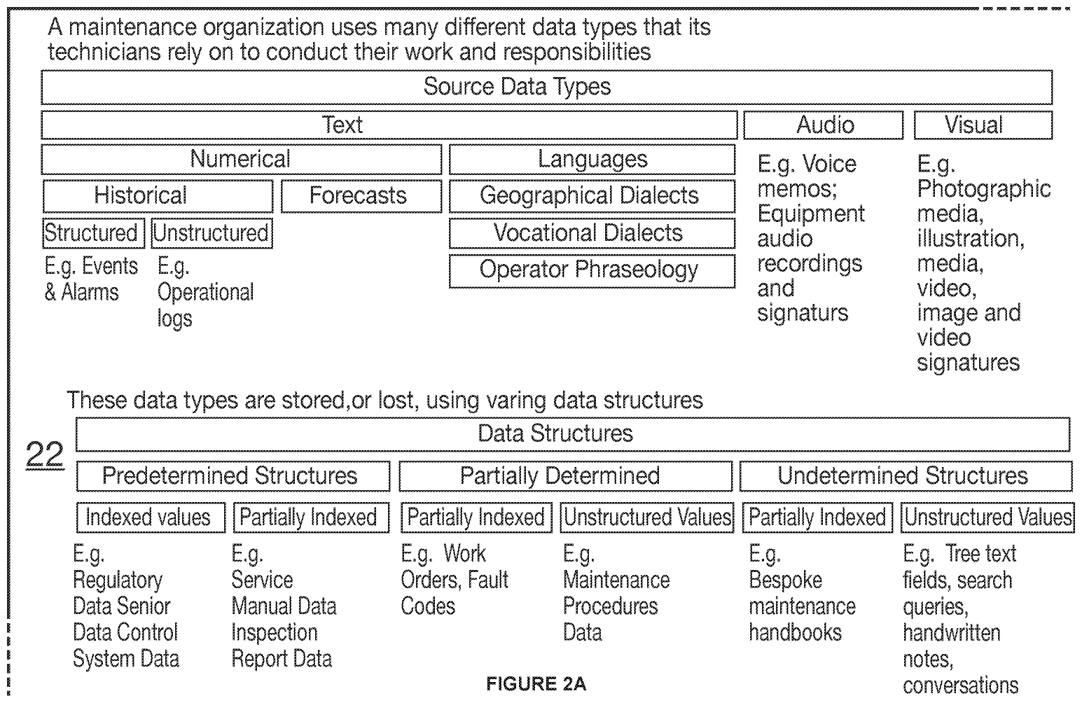

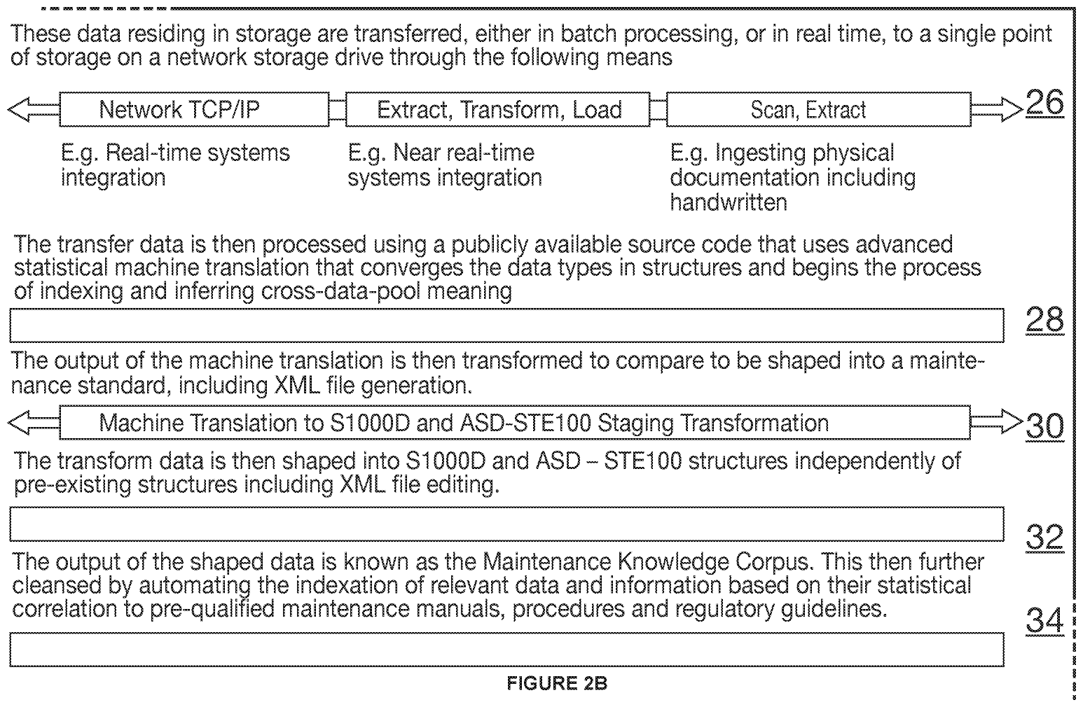

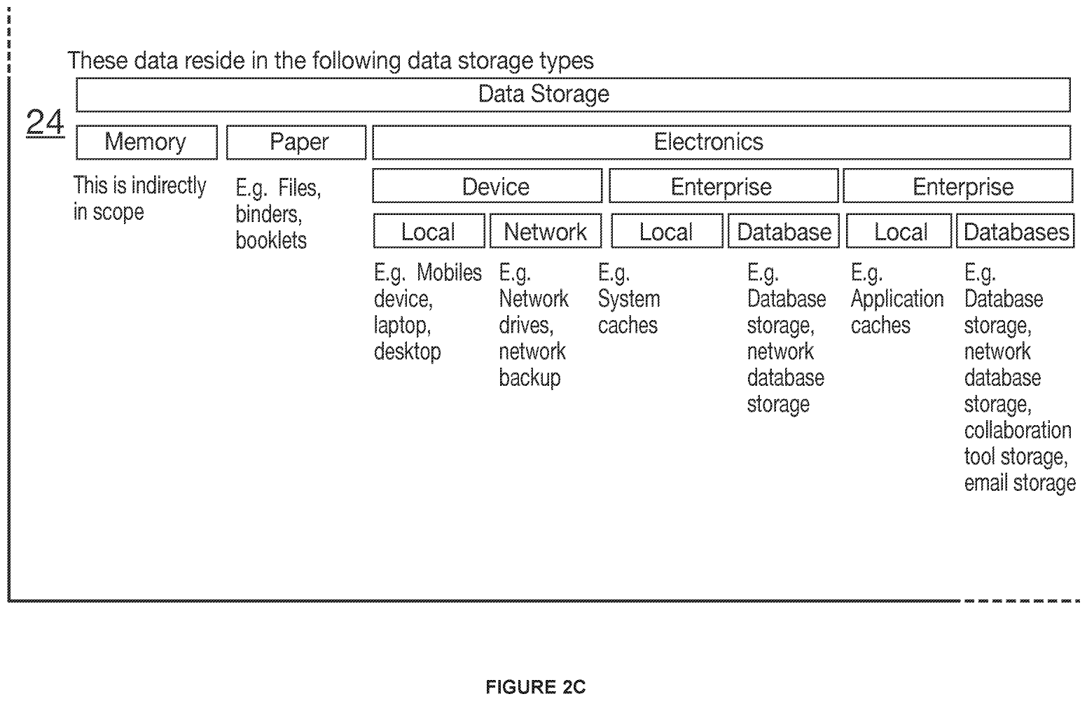

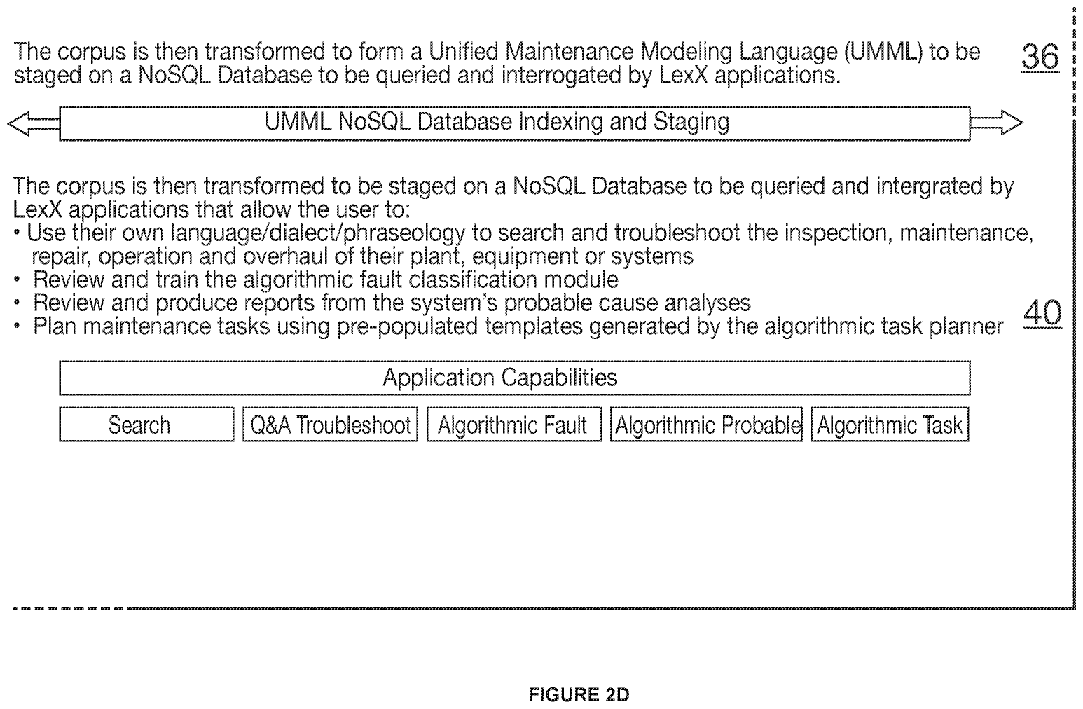

FIG. 2 depicts core back-end steps in the computer-implemented method of this embodiment. These back-end steps are directed to construction of structured service data which is queried or interrogated by the engineer or technician in identifying faults or defects in the assets or providing maintenance troubleshooting support and instructions for the assets. In constructing the structured service data, the method and system of this embodiment rely upon a vast range of data types stored in varied data structures as broadly designated at items 20 and 22 respectively. In a conventional manner, this data to be ingested by the system resides in a variety of data storage mediums or types as depicted at item 24. It is to be understood that the data to be ingested in implementation of the method and system of this embodiment is in the form of technical information relevant to the assets to be serviced including but not limited to components, devices, assemblies or sub-assemblies of an asset, such as the aircraft 16 illustrated in FIG. 1. The aircraft 16 shown could be replaced with a wind turbine or other asset and the system 10 and associated computer-implemented method of this embodiment when deployed on the wind turbine remain relevant and within the scope of the present invention.

FIG. 2 further illustrates the core back-end steps for providing maintenance troubleshooting support and instructions or identifying technical faults or defects in alternative aspects of the disclosure where:
1. the technical information is ingested at 26;
2. the ingested technical information is processed at blocks 28 to 36 to provide structured service data, this processing being based on maintenance requirements and information associated with the assets.

The ingestion of technical information at 26 may involve the transfer of data either in batch processing or in real-time to a storage source associated with the system of this embodiment of the disclosure. The storage source is either centralised at a single point of storage on a network storage drive or distributed across multiple network storage drives on virtual machines within a LAN, WAN or an internet-enabled cloud network. The transfer of data for ingestion may be through one or more of the following:
1. network TCP/IP transfer for example in real-time systems integration;
2. extraction, transformation and loading for example in near real-time systems integration;
3. scanning, extraction, transformation and loading for example ingesting physical documentation.

The processing of the technical information at 28 involves a preliminary step of translating data associated with the ingested technical information using statistical machine translation. In this example the statistical machine translation process is supported by publicly available source code that converges the data types and structures of the ingested information prior to transformation of the data into a standardised format file and data model.

In this embodiment processing of the ingested technical information to provide the structured serviced data also involves:
1. transforming the data from the statistical machine translation into the standardised format file including transformed data having common information data sets, such as generation of an XML file at 30;
2. shaping the standardised format or XML file by editing at least some of the transformed data based on maintenance requirements and information to provide a contextual knowledge file and database, such as shaping into S1000D and ASD-STE100 structures at 32 independently of pre-existing structures associated with the data sets.

In this embodiment the processing of the ingested technical information further involves:
1. cleansing the contextual knowledge file by indexing at least some data from the contextual knowledge file where this indexing is based on statistical correlation of said data to the maintenance requirements and information to provide an indexable knowledge file, such as automated indexing to pre-qualified maintenance manuals, procedures and regulatory guidelines at 34;
2. transforming the indexable knowledge file into a Unified Maintenance file including the structured service data for subsequent querying or interrogation by the engineer or technician, such as transforming to a Unified Maintenance Modelling Language (UMML) to be staged on a non-rational database at 36.

It is to be understood that the computer-implemented method of this embodiment also comprises the following core front-end steps:
1. receiving a technical observation from an engineer or technician tasked in servicing of the assets;
2. interrogating the structured service data constructed in the back-end, said interrogation being based on the technical observation from the engineer or technician;
3. providing maintenance troubleshooting support and instructions for assets and/or identifying technical faults or defects in the assets, said troubleshooting support and instructions or technical faults or defects being derived from the interrogation of the structured service data.

FIG. 2 schematically depicts these core front-end steps at 40 of this embodiment where:
1. the engineer or technician or other user adopting their own language/dialect/phraseology makes technical observations in the inspection, maintenance, repair, operation and overhaul of plant, equipment or systems;
2. the structured service data of in this example the non-relational database is interrogated based on the technical observations from the engineer or technician;
3. the system provides application capabilities in servicing of the equipment including fault or defect classification, probable cause analysis, and task planning.

FIGS. 3 and 4 are exemplary screenshots illustrating implementation of in particular the front-end components of the computer-implemented method and computer system of this embodiment of the disclosure. In this example the method and system operate in the context of a bus although it will be appreciated that application extends to virtually any other assets requiring servicing by an engineer or technician.

The computer-implemented method of the screenshots of FIGS. 3 and 4 depict the core front-end steps of:
1. in response to a technical observation from an engineer or technician, presenting a plurality of potential technical faults or defects for the assets;
2. enabling selection by the engineer or technician of one of the plurality of potential technical faults or defects;
3. depending on said selection, providing a structured workflow wherein a response is solicited from the engineer or technician and further interrogation of the structured service data is effected based on said response.

FIG. 3A of this example depicts the technical observation from the engineer or technician which in this case reads “The fuel pump is leaking”. The engineer or technician or maintenance engineer in this case uses natural language in their technical observation and interrogation of the structured service data or in this example the non-relational database is based on this unified maintenance modelling language. It will be understood that the disclosure although not limited to interrogation in natural language and maintenance language in this mode of operation provides the engineer or technician with dynamic interactive, human-to-machine, online communication and informational web search query support. The engineer or technician is thus free to use syntax and language of the system, plant or assets, and the contextual environment in which the equipment exists. The engineer or technician may also use a hybrid language that is understood in the context of the geographical region or the type of assets in the context of the work activity of the maintenance engineer, such as Denglisch, which is an informally used hybrid language of Deutsch (German) and English, with phrases like “oil geruch”.

FIGS. 3A and 3B are screenshots of a plurality of potential technical faults or defects derived from interrogation of the structured service data or non-relational database in response to the technical observation “The fuel pump is leaking”. It can be seen that the plurality of potential technical faults or defects are weighted depending on their relevance to the technical observation “The fuel pump is leaking”. This weighting which is shown in terms of its percentage relevancy is derived from the interrogation of the structured service data based on the engineer or technician's technical observation. In this example the potential faults or defects are displayed in order of their relevancy from “99% relevancy” to “73% relevancy”.

FIGS. 4A and 4B show presentations of a structured workflow according to this example of the technology where the engineer or technician has selected the first of the listed plurality of potential technical faults or defects headed “Fault isolation: SR1362-FI-451-451-4”. It is to be understood that the structured workflow may vary depending on the engineer or technician's selection of the potential technical fault or defect. Furthermore, the structured workflow is constructed from the structured service data of in this case the non-relational database. The structured workflow of this example solicits a response from the engineer or technician by presenting troubleshooting instructions contained in the structured workflow. For example the engineer or technician is in this instance presented with troubleshooting instructions “Evaporative fuel leak in engine” and “Poor fuel supply”. The response is in this case effected by the engineer or technician selecting “Poor fuel supply”. The structured workflow is in the form of a dynamic decision-tree of events that interacts with the engineer or technician in a dialogue wherein:
1. “Degraded fuel pump” is selected from further troubleshooting instructions or potential causes of “Clogged fuel filter” and “Degraded fuel pump” (see FIG. 4A);
2. the further troubleshooting instruction “Fuel rail pressure >psi at idle >psi full load” contained in the structured workflow is selected (see FIG. 4B).

In this example the maintenance instruction for the equipment reads “Replace fuel pump” and the engineer or technician in this case is given the opportunity to access and view schematics in order to assist with remediation of the equipment. The engineer or technician may confirm remediation by selecting “Yes” or select “No”. If “No” is selected the engineer or technician is returned to the structured workflow and the first of the troubleshooting instructions “Evaporative fuel leak in engine” and “Poor fuel supply”. It will be understood that selection of the alternative troubleshooting instruction “evaporative fuel leak in engine” directs the engineer or technician to different troubleshooting instructions contained in the decision-tree of the structured workflow. The engineer or technician in responding to these troubleshooting instructions is provided with alternative maintenance instructions for the equipment, such as “Replace purge pump” (not shown).

The structured workflow may vary in terms of the response solicited from the engineer or technician where rather than selecting predetermined troubleshooting instructions the engineer or technician adopts natural language in their response. It is also possible that the structured workflow may involve dynamic construction by the application of machine learning algorithms associated with the assets and contained in the structured service data or non-relational database. The structure workflow may additionally or alternatively adapt based on machine learning algorithms associated with behaviours of the engineer or technician tasked in servicing of the assets, as well as specific behaviours and behaviour patterns of the assets themselves.

The disclosure may also extend to Advanced Condition Monitoring and the Internet of Things (IoT), where the ingestion of technical information involves extraction of the technical information from multiple internet-enabled devices associated with the assets or the asset itself. In another variation on the technology the engineer or technician may image the assets or an associated identifier for the purposes of interrogating the structured service data depending on the identified assets. Alternatively the assets may be identified by the engineer or technician using a neuroimaging device for brain recognition of the assets to be serviced.

It will be understood that ingestion of technical information in implementation of this technology extends to manuals, work orders, spare and inventor data, maintenance logs and expert knowledge in varying formats including handwritten documents, industry standards, journals and volumes. In addition to large volumes of technical information contained in manuals, the technology extends to large volumes of historical maintenance data in the form of work orders, logs, sensor data, events and alarming data and reports that are difficult to access and thereby to gain insight. The method and system of this embodiment of the disclosure ingest this data in both digital and handwritten forms so that valuable knowledge and experience is accessible for implementing the technology harnessing in prognostics and solutions for asset maintenance. By virtue of consolidating all relevant technical information into one system and source, along with artificial intelligence (AI) capabilities such as statistical machine language translation, statistical machine learning and statistical image processing, the method and system of at least one embodiment provide the rapid isolation of faults or defects.

In processing of the ingested technical information, the technology provides an intelligent database structured in such a way as to store, structure and transform complex and voluminous data. This processing or structuring technique in certain embodiments allows the system to then model and tune data to apply machine learning, natural language processing techniques and image processing. This structuring of the ingested data is effective insofar as it enables the engineer or technician to interact with the technology in their natural language, dialects, hybrid language structures or idiosyncratic phraseology.

In at least one embodiment, the technology provides a user-friendly natural maintenance language interface that is intuitive and relatively easy to use. The technology may be deployed on a phone, tablet, wearable device or PC in accessing systems of record and learned user, asset and institutional behaviour to provide contextual solutions, guiding and instructing the technician or engineer through a relatively rapid and through maintenance processes. That is, the method and system have contextual search capability whereby a combination of words in the form of technical observations is intelligently interpreted to assist the engineer or technician in isolating a fault and commence interactive troubleshooting of the assets. The technician or maintenance engineer through dynamic conversational queries is able to identify failure root causes and to provide remediation instructions provided by the software. The remediation instructions may also be “actioned” to assist in completing tasks.

The computer-implemented method or associated software takes the form of an interactive user query overlay interface integrated with digital records, databases, applications or audio signatures, visual libraries and digital stores of handwritten documentation. The technology in at least one form anticipates and retrieves records that identify potential remediation paths based on interrogation of the system by the engineer or technician. The system will also generate predictions about the probable cause and conduct a root cause analysis of the behaviour that the engineer or technician has observed. In functioning for identification of technical faults or defects, the system is constructed to be responsive to the language syntax and context of both the engineer/technician and the asset that the engineer/technician is tasked in servicing or troubleshooting. More specifically the system dynamically presents troubleshooting decision-trees for the engineer or technician to interact with in a dialogue such that the path of the decision-tree will vary and continue to regenerate based on what the engineer or technician observes in the course of troubleshooting.

It is to be understood that the technology of at least one embodiment of the disclosure is configured to integrate with enterprise asset management software so as to effectively utilise records within these existing systems, for example work order history and inventory, and tooling status. The fault or defect identification and remediation capabilities of the present technology thus overlay enterprise asset management and other maintenance management software significantly enhancing the capability of this existing software. In certain embodiment, the software of the present disclosure uses an Application Programming Interface (API) to integrate with other systems such as document management, maintenance management, enterprise resource planning, maintenance and material management and enterprise asset management systems both at an application and database level. This means that the present technology leverages investments in these existing systems and utilises rich data associated with these systems. Rather than maintaining a single system of record akin to enterprise asset management and maintenance management systems, the present technology integrates with multiple applications, databases, systems of record, audio signatures, visual libraries and digital stores of handwritten documentation.

Now that certain embodiments of the disclosure have been described it be understood that the computer-implemented method and computer system for identifying technical faults/defects and/or providing maintenance instructions has at least the following advantages:
1. the system assists the engineer or technician to resolve problems at or around the time the fault or defects is encountered and through its interactive capabilities acts as virtual assistant to the engineer or technician in determining the cause of the fault or defect and providing the engineer or technician with maintenance troubleshooting support and instructions for remediation;
2. the system utilises AI capabilities, such as statistical machine language translation, statistical machine learning, and statistical image processing. This provides intelligent maintenance assistance platform that keeps maintenance and repair context at the forefront, while learning from user interactions and assets behaviour to improve average maintenance times;
3. the system applies machine learning and natural language processing techniques to industry-specific maintenance business processes by creating a novel Unified Maintenance Modelling Language (UMML) including fault/defect, issue and problem management, work scheduling, reporting, compliance and training in the context of scheduled and unscheduled maintenance;
4. the system incorporates further technological advancements in AI capabilities using dynamic interactive, human-to-machine, online communication combined with statistical machine learning processes that provide dynamic and on-going interactions with its user engineers or technicians effectively capturing and storing institutional maintenance knowledge gained throughout the life of the systems' interactions with its users and assets;
5. the system provides a simplistic and intuitive way to develop prognoses for faults or defects and to remediate them in servicing assets;
6. the system is configured to be adaptable and reactive to observed faults or defects whereby the engineer or technician explores possibilities relevant only to what is observed and being observed and thus provides guidance to remediate in the course of servicing assets;
7. the system provides improved interactivity of structured and varied data sets and information with engineers or technicians or other similar user types to aid the troubleshooting process for systems, plant and equipment.

Those skilled in the art will appreciate that the disclosure is described herein is susceptible to variations and modifications other than those specifically described. All such variations and modifications are to be considered within the scope of the present disclosure the nature of which is to be determined from the foregoing description.

The invention claimed is:

1. A computer-implemented method of providing troubleshooting support and maintenance instructions, the computer-implemented method comprising:
ingesting technical information relevant to an asset to be serviced;
processing the ingested technical information to provide structured service data, the processing being based on maintenance requirements and information associated with the asset;
receiving a technical observation from a user tasked in servicing of the asset;
interrogating the structured service data based on the technical observation received from the user; and
providing troubleshooting support and maintenance instructions for the asset derived from the interrogation of the structured service data, wherein the troubleshooting support and maintenance instructions enable servicing of the asset by the user.

2. The computer-implemented method of claim 1, further comprising presenting the structured service data to an application layer through which the structured service data is interrogated.

3. The computer-implemented method of claim 2, wherein the structured service data is presented to the application layer in a unified maintenance modelling language staged on a non-relational database.

4. The computer-implemented method of claim 3, wherein processing the ingested technical information comprises:
transforming data associated with the ingested technical information into a standardised format file and data model including transformed data having common information data sets; and
shaping the standardised format file by editing certain of the transformed data based on the maintenance requirements and information to provide a contextual knowledge file and database.

5. The computer-implemented method of claim 4, wherein processing the ingested technical information comprises cleansing the contextual knowledge file by indexing data from the contextual knowledge file based on a statistical correlation of the data to the maintenance requirements and information associated with the asset to provide an indexable knowledge file.

6. The computer-implemented method of claim 5, wherein processing the ingested technical information comprises transforming the indexable knowledge file into a unified maintenance file of the non-relational database including the structured service data for interrogation based on at least one technical query from the user.

7. The computer-implemented method of claim 6, wherein processing the ingested technical information comprises preliminary translating data associated with the ingested technical information using statistical machine translation to converge data types and structures of the ingested information prior to the transformation of the data into the standardised format file and data model.

8. The computer-implemented method of claim 1, further comprising:
in response to the technical observation from the user, presenting a plurality of potential technical defects for the asset derived from the interrogation of the structured service data;
enabling a selection by the user of one of the plurality of potential technical defects; and
providing a structured workflow configured to solicit a response from the user based on which further interrogation of the structured service data is effected to determine the maintenance instructions required to enable servicing of the asset.

9. The computer-implemented method of claim 8, wherein the response is solicited from the user by presenting at least one troubleshooting instruction contained within the structured workflow.

10. The computer-implemented method of claim 8, wherein presenting the plurality of potential defects comprises:
weighting the potential defects depending on their relevance to the technical observation, the weighting being derived from the interrogation of the structured service data; and
cause a display, by a display device, of the potential defects dependent on their weighting.

11. The computer-implemented method of claim 8, wherein providing the structured workflow comprises a dynamic construction of the workflow by an application of machine learning algorithms associated with the asset to be serviced by the user.

12. The computer-implemented method of claim 11, wherein a provision of the structured workflow comprises a dynamic construction of the workflow by an application of machine learning algorithms associated with behaviours of the user tasked in servicing of the asset and behaviours of the asset.

13. The computer-implemented method of claim 8, wherein the solicitation of the response in the structured workflow comprises a use of natural language by the user.

14. The computer-implemented method of claim 1, wherein receiving the technical observation comprises the user using natural language in the technical observation based on which the structured service data is interrogated.

15. The computer-implemented method of claim 1, wherein ingesting technical information comprises digitally imaging technical documents from which the technical information is obtained in an electronic form.

16. The computer-implemented method of claim 1, wherein ingesting technical information involves extracting the technical information from at least one of: a local area network, a wide area network, and an internet-enabled device associated with the asset to be serviced.

17. The computer-implemented method of claim 1, further comprising imaging the asset to be serviced, wherein the imaging is effective in identifying the asset for at least partly-automated interrogation of the structured service data depending on the identified asset.

18. The computer-implemented method of claim 17, wherein the asset is identified by the user using a neuroimaging device associated with the user for brain recognition of the asset to be serviced.

19. A computer-implemented method comprising:
ingesting technical information relevant to an asset to be serviced;
processing the ingested technical information to provide structured service data, the processing based on maintenance requirements and information associated with the asset;
receiving a technical observation from a user tasked in servicing of the asset;
interrogating the structured service data based on the technical observation received from the user; and
identifying a technical defect in the asset derived from the interrogation of the structured service data.

20. A computer system comprising:
a processor; and
a memory device which stores a plurality of instructions which, when executed by the processor, cause the processor to:
facilitate an ingestion of technical information relevant to an asset to be serviced;
process the ingested technical information to provide structured service data, the processing being based on maintenance requirements and information associated with the asset;
receive at least one technical observation from a user tasked in servicing the asset;
interrogate the structured service data based on the at least one technical observation; and
provide troubleshooting support and maintenance instructions for the asset derived from the interrogation of the structured service data, wherein the troubleshooting support and maintenance instructions enable servicing of the asset by the user.

21. A computer system comprising:
a processor; and
a memory device which stores a plurality of instructions which, when executed by the processor, cause the processor to:
facilitate an ingestion of technical information relevant to an asset to be serviced;
process the ingested technical information to provide structured service data, the processing being based on maintenance requirements and information associated with the asset;
receive at least one technical observation from a user tasked in servicing the asset;
interrogate the structured service data based on the at least one received technical observation; and
identify a technical defect in the asset derived from the interrogation of the structured service data.
